(19) United States
(12) Patent Application Publication
(10) Pub. No.: US 2026/0070057 A1
(43) Pub. Date: Mar. 12, 2026

(54) FLUIDIC MODULE, FLUID HANDLING DEVICE AND METHOD WITH TEMPORARY PRESSURE EQUALIZATION IN A PNEUMATIC CHAMBER

(71) Applicant: Hahn-Schickard-Gesellschaft für angewandte Forschung e.V., Villingen-Schwenningen (DE)

(72) Inventors: Gustav GRETHER, Müllheim (DE); Daniel KAINZ, Freiburg im Breisgau (DE); Jan LÜDDECKE, Neuenburg am Rhein (DE); Nils PAUST, Freiburg (DE)

(21) Appl. No.: 19/336,669

(22) Filed: Sep. 23, 2025

Related U.S. Application Data
(63) Continuation of application No. PCT/EP2024/056867, filed on Mar. 14, 2024.

(30) Foreign Application Priority Data
Mar. 23, 2023 (DE) 10 2023 202 639.2

(51) Int. Cl. B01L 3/00

(52) U.S. Cl. CPC B01L 3/50273; B01L 2300/0877; B01L 2300/14; B01L 2400/0409

(57) ABSTRACT

A fluidic module having a mixing chamber and a pneumatic chamber. A first fluid path fluidically connects the mixing chamber to the pneumatic chamber to centrifugally transfer liquid out of the mixing chamber into the pneumatic chamber. A second fluid path fluidically connects the pneumatic chamber to the fluid outlet. A pressure equalization channel fluidically connects the pneumatic chamber to the surroundings, the mixing chamber and/or the fluid outlet to enable a pressure equalization, and leads into the pneumatic chamber at a pressure equalization mouth. The pressure equalization mouth is closed by liquid that is transferred into the pneumatic chamber via the first fluid path after a defined volume of the liquid has been transferred into the pneumatic chamber to compress, after closing, in case of a further centrifugal transfer of liquid out of the mixing chamber into the pneumatic chamber, a gas enclosed in the pneumatic chamber.

### CROSS-REFERENCES TO RELATED APPLICATIONS

This application is a continuation of copending International Application No. PCT/EP2024/056867, filed Mar. 14, 2024, which is incorporated herein by reference in its entirety, and additionally claims priority from German Application No. DE 10 2023 202 639.2, filed Mar. 23, 2023, which is incorporated herein by reference in its entirety.

The present invention relates to fluidic modules, fluidic handling devices and methods that enable switching a liquid via a first fluid path and a second fluid path using a pneumatic chamber, wherein it depends on an expansion rate of a compressed gas in the pneumatic chamber whether the liquid is transferred from the pneumatic chamber via the first fluid path or the second fluid path. In particular, the invention relates to such devices and methods that are suited for handling liquids in a centrifugal microfluidic system.

### BACKGROUND OF THE INVENTION

Many processes that may be implemented on centrifugal fluidic modules, which may also be referred to as microfluidic cartridges, contain mixing processes. In these processes, e.g., liquids are mixed, lyophilized pellets are dissolved, or particles are agitated. The components to be mixed often have different densities, e.g. when mixing blood plasma with buffers or dissolving lyophilized pellets.

To enable a controlled mixing process, a valve that keeps the liquid in the mixing chamber during mixing and then allows controlled further transfer is required. For example, capillary valves, siphon structures or pneumatic valves can be used for isothermal dispensers. The breakthrough frequencies of capillary valves are too low to enable robust and flexible implementation. Siphon structures may only be used for highly hydrophilic or highly hydrophobic liquids. For slightly hydrophilic or hydrophobic liquids, only pneumatic valves can be used.

Different approaches for mixing are known. Isothermal devices (players), reciprocal mixing or shake-mode mixing are used as mixing operations.

Reciprocal mixing takes a long time and is described, e.g., in WO 2005/061084 A1 or in Z. Noroozi et al., “Reciprocating flow-based centrifugal microfluidics mixer”, Review of Scientific Instruments, Edition 80, June 2009. In reciprocal mixing, liquids are pumped between two chambers on a rotating system and are mixed through this.

In shape-mode mixing, components with different densities may be efficiently mixed in frequency zero crossings. Shake-mode mixing, which is also referred to as batch-mode mixing, aims to mix substances in a rotating system. Through an alternating frequency protocol, inertial forces are generated during acceleration phases, which, in conjunction with the geometry of the mixing chamber, creates vortices to mix the substances. Such a process is described, e.g., in M. Grumann et al., “Batch-mode mixing on centrifugal microfluidic platforms”, Review of Scientific Instruments, Pages 560-565, March 16 2005.

Here, a pneumatic valves is understood to be a microfluidic valve in which centrifugal forces generate a pneumatic pressure in a pneumatic chamber, with said pressure being used for selectively forwarding the liquids towards the radial inner side or via a siphon. I. Schwarz et al., “System-level network simulation for robust centrifugal-microfluidic lab-on-a-chip systems”, Lab on a Chip, Edition 16, Pages 1873-1885, Mar. 29, 2016 describes an example of such a pneumatic valve. The same describes fluidic structures that form a pneumatic valve and that are used for mixing. The fluidic structures comprise a mixing chamber and a pneumatic chamber. A fluid channel branches off at a T crossing into a first fluid channel leading into the mixing chamber and a second fluidic channel comprising a siphon valve. First, liquid is driven out of an inlet chamber into the pneumatic chamber under rotation. Subsequently, mixing takes place, wherein a repeated change of the rotation rate takes place with such acceleration/deceleration rates that the siphon valve does not switch. After mixing has finished, a deceleration takes place with such a deceleration rate that the siphon valve switches and the liquid is transferred through the second fluid channel.

DE 10 2013 203 293 A1 describes a structure for pneumatic switching, in which a liquid is guided with a pneumatic valve via different channels towards the radial outside. Which of the channels is to be used may be determined by the frequencies and accelerations. The structure comprises a compression chamber, wherein an inlet channel, a first outlet channel and a second outlet channel are fluidically coupled to the compression chamber. The first outlet channel and the second outlet channel are implemented such that when expanding a gas compressed in the compression chamber with a first expansion rate the liquid is guided via the first outlet channel and when expanding the compressed gas with a second expansion rate smaller than the first expansion rate the liquid is guided via the second outlet channel.

Methods for pumping liquids inward contrary to the centrifugal forces in centrifugal-microfluidic systems are described in DE 10 2012 202 775 A1, for example. Through centrifugal forces, a liquid is forced into a closed chamber where it compresses an available compressible medium, such as air. In case of a strong deceleration, the liquid is pumped towards the radial inside via an outlet channel with a low fluidic resistance.

From WO 2014/198703 A1, the use of a diffusion barrier that may be used to reduce the vapor pressure in the chamber of a pneumatic valve is known. In this case, the chamber is divided into two portions and is connected via a channel. It is the aim that the liquid enters only into the first portion. Through the channel, the air saturates itself in a delayed way in the second portion and the vapor pressure slowly increases.

The present invention is made on the basis of a conventional pneumatic valve consisting of a mixing chamber, a pneumatic chamber and an outlet chamber. The mixing chamber is located radially further inwards than the pneumatic chamber. A siphon channel with a low fluidic resistance connects the pneumatic chamber and the outlet chamber. A resistance channel with a high fluidic resistance leads from the mixing chamber to the siphon channel via T crossing and therefore connects the mixing chamber and the pneumatic chamber. Liquid is applied into the mixing chamber and reaches the pneumatic chamber through centrifugal forces. Pneumatic pressure is generated in the pneumatic chamber, wherein said pneumatic pressure may be switched by the siphon to transfer the liquid further towards the radial inside or outside.

With the entry of a liquid into the pneumatic chamber, the air saturates itself and vapor pressure is created. At low frequencies, the vapor pressure may lead to the liquid being fully displaced from the chamber. This may lead to two problems. On the one hand, this may empty the T crossing, leading to the formation of bubbles that prevent switching the siphon. On the other hand, the liquid in the siphon may rise and switch the same prematurely. Thus, the conventional pneumatic valve cannot be implemented robustly for shake-mode mixing with frequency zero crossings.

The lower the initial saturation of the air and the higher the temperature, the greater the vapor pressure. Fluidic cartridges are often stored in dry conditions, e.g. since humidity-sensitive reagents are prestored. This increases the risk of malfunction, as well as high or monotonically rising temperatures which are required for many assays.

Without reducing the vapor pressure, there is currently no efficient and robust mixing method for devices with constant or rising temperatures for mixing and transferring slightly hydrophilic or slightly hydrophobic liquids with density differences. In addition, the implementation of a conventional pneumatic valve may be very complex, and a robust operation may not be guaranteed for some other applications (e.g. in case of space constraints).

It is the object of the invention to provide a fluidic module, a fluid handling device and a method that enables mixing of liquids and/or mixing of a liquid and solids in a robust way. This object is solved by a fluidic module according to claim 1, a fluid handling device according to claim 12, and a method according to claim 13.

### SUMMARY

An embodiment may have a fluidic module, comprising: a mixing chamber, a pneumatic chamber, a fluid outlet, a first fluid path that fluidically connects the mixing chamber to the pneumatic chamber to be able to centrifugally transfer liquid out of the mixing chamber into the pneumatic chamber, a second fluid path that fluidically connects the pneumatic chamber to the fluid outlet, a pressure equalization channel that fluidically connects the pneumatic chamber to the surroundings, the mixing chamber and/or the fluid outlet to enable a pressure equalization, and that leads into the pneumatic chamber at a pressure equalization mouth, wherein this pressure equalization mouth is arranged at such a position that it is closed by liquid that is transferred into the pneumatic chamber via the first fluid path after a defined volume of the liquid has been transferred into the pneumatic chamber to compress, after closing, in a further centrifugal transfer of liquid out of the mixing chamber into the pneumatic chamber, a gas enclosed in the pneumatic chamber. wherein an expansion of the compressed gas in the pneumatic chamber with a first expansion rate causes liquid to be transferred out of the pneumatic chamber into the mixing chamber via the first fluid path, and wherein an expansion of the compressed gas in the pneumatic chamber with a second expansion rate larger than the first expansion rate causes liquid to be transferred out of the pneumatic chamber to the fluid outlet via the second fluid path.

Another embodiment may have a fluid handling device, comprising: a fluidic module according to the invention, and a drive device configured to rotate the fluidic module, wherein the drive device is configured to: in a first phase, rotate the fluidic module with a rotation frequency to transfer liquid out of the mixing chamber into the pneumatic chamber and to compress gas enclosed in the pneumatic chamber, in a second phase, reduce the rotation frequency with a deceleration rate at which the compressed gas expands with an expansion rate that causes liquid to be transferred out of the pneumatic chamber into the mixing chamber via the first fluid path, in a third phase, control the rotation frequency to switch several times between rotations in different directions or to switch several times between different rotation frequencies in one rotation direction in order to cause mixing of the liquid in the mixing chamber, in a fourth phase, increase the rotation frequency to transfer the liquid out of the mixing chamber into the pneumatic chamber and to compress gas enclosed in the pneumatic chamber, in a fifth phase, reduce the rotation frequency with a deceleration rate at which the compressed gas expands with an expansion rate that causes liquid to be transferred out of the pneumatic chamber to the fluid outlet via the second fluid path.

Another embodiment may have a method for mixing one or several liquids using a fluidic module according to the invention, comprising: introducing one or several liquids into the mixing chamber, rotating the fluidic module with a rotation frequency to transfer liquid out of the mixing chamber into the pneumatic chamber and to compress gas enclosed in the pneumatic chamber, reducing the rotation frequency with a deceleration rate at which the compressed gas expands with an expansion rate that causes liquid to be transferred out of the pneumatic chamber into the mixing chamber via the first fluid path, controlling the rotation frequency to switch several times between rotations in different directions or to switch several times between different rotation frequencies in one rotation direction in order to cause mixing of the liquid in the mixing chamber and/or to cause mixing of the liquid in the mixing chamber with solids prestored in the mixing chamber, increasing the rotation frequency in order to transfer the liquid out of the mixing chamber into the pneumatic chamber and to compress gas enclosed in the pneumatic chamber, and reducing the rotation frequency with a deceleration rate at which the compressed gas expands with an expansion rate that causes liquid being transferred out of the pneumatic chamber to the fluid outlet via the second fluid path.

Examples of the invention provide a fluidic module with a mixing chamber, a pneumatic chamber, a fluid outlet, a first fluid path, a second fluid path, and pressure equalization channel. The first fluid path fluidically connects the mixing chamber to the pneumatic chamber to centrifugally transfer liquid out of the mixing chamber into the pneumatic chamber. The second fluid path fluidically connects the pneumatic chamber to the fluid outlet. The pressure equalization channel fluidically connects the pneumatic chamber to the surroundings, the mixing chamber and/or the fluid outlet to enable a pressure equalization. The pressure equalization channels leads into the pneumatic chamber at a pressure equalization mouth, wherein this pressure equalization mouth is arranged at such a position that it is closed by liquid that is transferred into the pneumatic chamber via the first fluid path after a defined volume of the liquid has been transferred into the pneumatic chamber to compress, after closing, in case of a further centrifugal transfer of liquid out of the mixing chamber into the pneumatic chamber, a gas enclosed in the pneumatic chamber. An expansion of the compressed gas in the pneumatic chamber with a first expansion rate causes liquid to be transferred out of the pneumatic chamber into the mixing chamber via the first fluid path, and an expansion of the compressed gas in the pneumatic chamber with a second expansion rate larger than the first expansion rate causes liquid to be transferred out of the pneumatic chamber to the fluid outlet via the second fluid path.

The mixing chamber, the pneumatic chamber, the first fluid path, the second fluid path and the fluid outlet, which may be connected to an outlet chamber, form a pneumatic valve for switching of liquids, wherein a vapor pressure in the pneumatic chamber may be reduced at least partially by the pressure equalization channel. The pressure equalization channel enables a flexible implementation and a robust operation of the pneumatic valve and therefore a robust mixing by using the pneumatic valve. Once liquid enters the pneumatic chamber via the first fluid path, the gas saturates itself, and the vapor pressure generated may exit via the pressure equalization channel. The pressure equalization channel is closed if a defined liquid volume has entered the pneumatic chamber. Upon further entry of liquid, a pneumatic pressure is generated that may be used in case of high deceleration rates for the transfer of liquids via the second fluid path, e.g. for switching a siphon channel of the second fluid path. In case of low deceleration rates, the liquid is pumped back into the mixing chamber. If the vapor pressure has been fully reduced, the pneumatic chamber empties into the pneumatic chamber at low deceleration rates only up to the radial position of the mouth of the pressure equalization channel. This allows realizing strong shake modes with frequency zero crossings without transferring liquids through the second fluid path. Without the pressure equalization channel, this cannot be achieved reliably.

In examples, for a liquid flow from the pneumatic chamber to the fluid outlet, the second fluid path comprises a lower fluidic resistance than the first fluid path for a liquid flow from the pneumatic chamber into the mixing chamber, and the second fluid path comprises a channel portion that extends radially further inwards than a radially innermost portion of the first fluid path. Thus, depending on the rate of expansion of the gas (representing a compressible medium), it is possible to suitably transfer the liquid either through the first fluid path or through the second fluid path.

In examples, the second fluid path comprises a siphon channel whose apex is arranged radially further inwards than a radially innermost portion of the first fluid path. The radially innermost portion of the first fluid path may be the mouth of the first fluid path into the mixing chamber or an apex of a siphon channel of the first fluid path. Thus, via the siphon channel of the second fluid path, it is possible to transfer the liquid to the fluid outlet arranged radially further outwards than the mouth of the second fluid path into the pneumatic chamber. Furthermore, this may enable reliably implementing stable mixing by subjecting the fluidic module to a rotation at a rotation frequency protocol in which priming of the siphon channel of the second fluid path is prevented during mixing.

In examples, the fluid outlet is arranged radially further inwards than a radial position at which the second fluid path leads into the pneumatic chamber. Thus, examples enable pumping of liquid radially inwards after having performed shape-mixing with frequency zero crossings, for example. In examples, the fluid outlet is arranged radially further inwards than a radial position at which the first fluid path leads into the mixing chamber or than an apex of a siphon of the first fluid path if the first fluid path comprises a siphon.

In examples, an end, spaced apart from the pressure equalization opening, of the pressure equalization channel leads into the surroundings or into a de-aerated region of the fluidic structures of the fluidic module, e.g. of the mixing chamber or an outlet chamber into which the second fluid path opens. In such examples, the pressure equalization channel may also be referred to as a de-aeration channel and the vapor pressure generated may be reliably reduced until the liquid entering the pneumatic chamber closes the pressure equalization opening.

In examples, the position of the pressure equalization mouth is located radially further inwards than a position at which the first fluid path leads into the pneumatic chamber. This makes it possible to hold a defined liquid volume in the pneumatic chamber even during shake-mode mixing with frequency zero crossings so that emptying the first fluid path during the shake-mode mixing may be prevented.

In examples, the first fluid path and the second fluid path comprise a mutual channel portion that leads into the pneumatic chamber, wherein the mutual channel portion is divided at a branch into a channel portion of the first fluid path opening into the mixing chamber and a channel portion of the second fluid path leading to the fluid outlet. Just like with conventional pneumatic valves, the first fluid path and the second fluid path may form a T crossing. This makes it possible to be able to use existing findings with respect to the implementation of the first and second fluid paths to achieve the functionalities described herein.

In examples, the first fluid path leads into the mixing chamber in a radially outer region of the mixing channel. Thus, the mixing chamber may be emptied by means of the centrifugal force via the first fluid path up to the position at which the first fluid path leads into the same. In examples, the first fluid path leads into the mixing chamber at a radially outer end of the mixing chamber, accordingly enabling full emptying. In examples, the first and second fluid paths leads into the pneumatic chamber in a radially outer region of the pneumatic chamber. In examples, a mutual channel portion of the first and second fluid paths leads into the pneumatic chamber.

In examples, the fluidic module further comprises an inlet chamber or several inlet chambers that are fluidically coupled to the mixing chamber to centrifugally transfer liquid out of the one or the several inlet chambers into the mixing chamber. Thus, examples enable an automated introduction of liquid into the mixing chamber on a centrifugal platform by using the inlet chamber(s).

In examples, the fluidic module further comprises an outlet chamber into which an end, spaced apart from the pneumatic chamber, of the second fluid path leads and that is configured to receive liquid transferred via the second fluid path to the fluid outlet. Thus, after mixing, examples enable a transfer of the liquid into an outlet chamber that may be configured for processing and/or evaluation of the mixed liquid.

In embodiments, the first fluid path comprises a siphon channel configured to switch if a liquid level in the mixing chamber exceeds a predetermined level. This makes it possible to enable bubble-free filling of the following fluidic structures.

Examples provide a fluid handling device that comprises a fluidic module as described herein and a drive device. The drive device is configured to:
in a first phase, rotate the fluidic module with a rotation frequency to transfer liquid out of the mixing chamber into the pneumatic chamber and to compress gas enclosed in the pneumatic chamber,
in a second phase, reduce the rotation frequency with a deceleration rate at which the compressed gas expands with an expansion rate that causes liquid to be transferred out of the pneumatic chamber into the mixing chamber via the first fluid path,
in a third phase, control the rotation frequency to switch several times between rotations in different directions or to switch several times between different rotation frequencies in one rotation direction in order to cause mixing of the liquid in the mixing chamber,
in a fourth phase, increase the rotation frequency to transfer the liquid out of the mixing chamber into the pneumatic chamber and to compress gas enclosed in the pneumatic chamber,
in a fifth phase, reduce the rotation frequency with a deceleration rate at which the compressed gas expands with an expansion rate that causes liquid to be transferred out of the pneumatic chamber to the fluid outlet via the second fluid path.

In examples, the drive device is configured to apply a rotation to the fluidic module according to a certain frequency protocol in order to cause the functionalities described herein, e.g. rotations with corresponding rotation frequencies and deceleration rates in the first to fifth phases.

Examples provide a method for mixing one or several liquids using a fluidic module as described herein, comprising:
introducing one or several liquids into the mixing chamber,
rotating the fluidic module with a rotation frequency to transfer liquid out of the mixing chamber into the pneumatic chamber and to compress gas enclosed in the pneumatic chamber,
reducing the rotation frequency with a deceleration rate at which the compressed gas expands with an expansion rate that causes liquid to be transferred out of the pneumatic chamber into the mixing chamber via the first fluid path,
controlling the rotation frequency to switch several times between rotations in different directions or to switch several times between different rotation frequencies in one rotation direction in order to cause mixing of the liquid in the mixing chamber and/or to cause mixing of the liquid in the mixing chamber with solids prestored in the mixing chamber,
increasing the rotation frequency in order to transfer the liquid out of the mixing chamber into the pneumatic chamber and to compress gas enclosed in the pneumatic chamber, and
reducing the rotation frequency with a deceleration rate at which the compressed gas expands with an expansion rate that causes liquid being transferred out of the pneumatic chamber to the fluid outlet via the second fluid path.

Thus, examples provide fluid handling devices and methods that are suitable for robust mixing by changing the rotation frequency and/or changing the rotation direction. When reducing the rotation frequency with a deceleration rate at which the compressed gas expands with an extension rate that causes liquid to be transferred out of the pneumatic chamber into the mixing chamber via the first fluid path, the pneumatic chamber is not emptied fully, but only up to the radial position at which the pressure equalization chamber leads into the same. Thus, full emptying of the first fluid path may be reliably prevented during the mixing process even in case of frequency zero crossings of the mixing process.

In examples, introducing one or several liquids into the mixing chamber is done upon a rotation of the fluidic module to centrifugally transfer the one or several liquids out of one or several inlet chambers into the mixing chamber. This enables further automation on a centrifugal platform.

In examples, an overpressure created by saturation of the gas in the pneumatic chamber when the liquid is transferred from the mixing chamber into the pneumatic chamber is at least partially reduced via the pressure equalization chamber. This makes it possible to at least partially for fully reduce the vapor pressure and/or dissipation of gases out of the liquid, e.g. after a pellet has been dissolved, before the pressure equalization opening is closed by the liquid.

### BRIEF DESCRIPTION OF THE DRAWINGS

Embodiments of the present invention will be detailed subsequently referring to the appended drawings, in which:

FIG. 1 shows a schematic illustration of an example of an inventive fluidic module;

FIG. 2 shows a schematic illustration of an example of an inventive fluidic module with inlet chambers and an outlet chamber;

FIG. 3 shows a schematic illustration of an example of an inventive fluidic module with a siphon in the first fluid path;

FIG. 4A through FIG. 4F show schematic illustrations of the examples shown in FIG. 3 in different operation phases A to F;

FIG. 5 shows a schematic illustration of a rotation frequency protocol for performing an example of an inventive method;

FIG. 6 shows a schematic illustration of an example of an inventive fluidic module with an outlet chamber arranged radially inside;

FIG. 7A shows a schematic illustration of an example of an inventive fluidic module with closed fluidics;

FIGS. 7B and 7C show schematic illustrations of examples of inventive fluidic modules in which the pressure equalization channel is connected to an outlet chamber or inlet chamber, respectively; and

FIGS. 8A and 8B show schematic illustrations of examples of inventive fluid handling devices.

### DETAILED DESCRIPTION OF THE INVENTION

The following describes examples of the present disclosure in detail, using the accompanying drawings. It should be noted that identical elements or elements having the same functionality are designated by identical or similar reference numerals, and repeated descriptions of elements designated by identical or similar reference numerals are typically omitted. In particular, identical or similar elements may be assigned reference numerals that have the same number with a different lowercase letter or no lowercase letter. Descriptions of elements that have identical or similar reference numerals may be interchangeable. The following description provides many details to provide a more thorough explanation of examples of the disclosure. However, it will be apparent to those skilled in the art that other examples may be implemented without these specific details. Features of the various examples described may be combined with each other, unless features of a particular combination are mutually exclusive or such a combination is expressly excluded.

Before examples of the present disclosure are explained in more detail, definitions of some terms used herein are provided.

As is obvious to those skilled in the art, the term liquid, as used herein, includes in particular also liquids contained in solid components, such as suspensions, biological samples and reagents.

A siphon, or siphon channel, is here understood to be a microfluidic channel or a portion of a microfluidic channel in a fluidic module (a centrifugal microfluidic cartridge), wherein an entry and an exit of the channel (when being used in a centrifugal microfluidic system or a centrifugal microfluidic platform) have a larger distance to the rotation center than an intermediate area of the channel. A siphon apex (or crest) is the region of a siphon channel and a fluidic module with a minimum distance to the rotation center. Since, compared to the arrangement of a typical siphon in the gravitational field of the earth, the apex of such a siphon is inverted in the centrifugal field, such a siphon could be referred to as an inverted siphon in the centrifugal field.

A fluidic module is understood to be a module, such as a cartridge, comprising microfluidic structures configured to enable handling of liquids, as described herein. A centrifugal microfluidic module (cartridge) is understood to be a corresponding module subject to a rotation, e.g. in the form of a fluidic module usable in a rotation body or a rotation body. In examples of the present invention, the fluidic module is a centrifugal microfluidic fluidic module.

A pneumatic chamber is herein understood to be a fluid chamber in which a pneumatic pressure is generated by compressing a compressible medium located therein.

If this application refers to a fluid channel, it means a structure whose length dimension from a fluid inlet to a fluid outlet is larger, e.g. more than five times or more than 10 times larger, than the dimension, or dimensions, that define the flow cross-section. Thus, a fluid channel has a flow resistance for a flow-through from the fluid inlet to the fluid outlet. Contrary, herein, a fluid chamber is a chamber having such dimensions that when the chamber experiences flow-through, a negligible flow resistance occurs compared to connected channels, which may be 1/100 or 1/1000 of the flow resistance of the channel structure connected to the chamber with the lowest flow resistance.

Examples of the invention can be applied in particular in the field of centrifugal microfluidics, which involves the processing of liquids in the picoliter to milliliter range. Accordingly, the fluidic structures can have suitable dimensions in the micrometer range for handling corresponding liquid volumes.

Herein, the expression radial/radially means radially with respect to the rotation center around which the fluidic module or the rotation body can be rotated. Thus, in the centrifugal field, a radial direction away from the rotation center is radially decreasing and a radial direction towards the rotation center is radially increasing.

A fluid channel whose start is closer to the rotation center than its end is therefore radially decreasing, while a fluid channel whose start is further away from the rotation center than its end is radially increasing. A channel having a radially increasing portion therefore also comprises directional components that radially increase or that extend radially inwards. It is clear that such a channel does not have to extend exactly along a radial line, but may extend at an angle to the radial line or it may be curved. Radially further outwards (or radially further outside) therefore means further away from the rotation center, and radially further inwards (or radially further inside) therefore means closer to the rotation center.

Unless otherwise specified herein, temperature-dependent variables shall be assumed to be at room temperature (20° C.).

Examples of the present disclosure provide microfluidic structures and methods in a centrifugal-microfluidic system for centrifugal-pneumatic switching of liquids and in particular structures and methods that enable mixing of liquids and/or liquids and solids. In particular, it is the goal of the invention to be used on simple isothermal devices or centrifuges, even though this does not necessarily have to be the case.

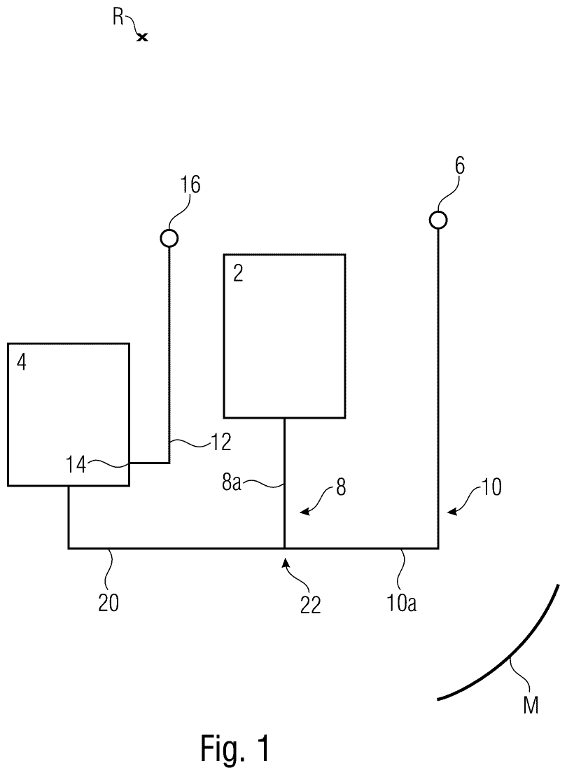

An example of an inventive fluidic module M is shown in FIG. 1. The fluidic module M comprises a mixing chamber 2, a pneumatic chamber 4, a fluid outlet 6, a first fluid path 8, a second fluid path 10, and a pressure equalization channel 12. The fluidic module M is rotatable around a rotation center R that is schematically shown in FIG. 1. The first fluid path 8 fluidically connects the mixing chamber 2 to the pneumatic chamber 4. The first fluid path 8 leads into the mixing chamber 2 in a radially outer region of the mixing chamber 2, preferably at a radially outer end to enable full emptying of the mixing chamber via the first fluid path 8. Overall, the first fluid path 8 radially decreases between the mixing chamber and the pneumatic chamber 4 so that liquid may be transferred centrifugally out of the mixing chamber 2 into the pneumatic chamber 4 via the first fluid path 8, upon rotation of the fluidic module M. The first fluid path 8 may lead into the pneumatic chamber 4 in a radially outer region. In examples, the first fluid path 8 leads into the pneumatic chamber 4 at the radially outer end of the pneumatic chamber 4. The second fluid path 10 fluidically connects the pneumatic chamber 4 to the fluid outlet 6. The second fluid path 10 leads into the pneumatic chamber 4 in a radially outer region of the same. In examples, the second fluid path 10 leads into the pneumatic chamber 4 at the radially outermost end of the pneumatic chamber 4 to enable full emptying of the pneumatic chamber 4 via the second fluid path. The pressure equalization channel 12 leads into the pneumatic chamber 4 at a mouth (or opening) 14.

The mouth 14 is arranged in such a radial position that it is closed by a liquid transferred into the pneumatic chamber 4 via the first fluid path 8 after a defined volume of the liquid has been transferred into the pneumatic chamber 4. In examples, the mouth 14 may be arranged at a position that is located radially further inwards then the position at which the first fluid path 8 leads into the pneumatic chamber 4. The defined volume may be given by the cross-sectional area of the pneumatic chamber 4 when viewed in the radial direction and the radial difference between the positions of the mouths of the pressure equalization channel 12 and the first fluid path 8.

In the example shown, the first fluid path and the second fluid path 10 comprise a mutual channel portion 20 that leads into the pneumatic chamber 4 and that branches off into a channel portion 8a fluidically connected to the mixing chamber 2 and a channel portion 10a fluidically connected to the fluid outlet 6. The branch may be implemented by means of a T crossing 22. The branch may be implemented by means of any crossing (or intersection) with three channels. In examples, the channel portion 8a extends to be radially decreasing and leads into a channel formed by the mutual channel portion 20 and the channel portion 10a. Thus, the first fluid path 8 is therefore formed by the mutual channel portion 20 and the channel portion 8a, and the second fluid path is therefore formed by the mutual channel portion 20 and the channel portion 10a. In alternative examples, the fluid paths 8 and 10 may also separately lead into the pneumatic chamber, e.g. in positions that are spaced apart azimuthally, wherein further reference is made to the corresponding teachings of DE 10 2012 202 775 A1.

Once the opening 14 is closed by the liquid, a compressible medium (gas), such as air, that is enclosed there may be compressed by a further centrifugal transfer of liquid into the pneumatic chamber 4. Before the pressure equalization channel is closed, an overpressure created by saturation of the gas in the pneumatic chamber 4 when the liquid is transferred from the mixing chamber 2 into the pneumatic chamber 4 may at least be partially reduced via the pressure equalization channel. The cause for such an overpressure may be the vapor pressure or the dissipation of gasses from the liquid when, e.g. a pellet has been dissolved in the mixing chamber 2. In the example shown, the pressure equalization channel is fluidically coupled to the surroundings 16 and therefore represents a de-aeration channel (or ventilation channel). In other examples, the pressure equalization channel may be fluidically connected to the mixing chamber 4 or the fluid outlet 6 to enable a pressure equalization with the mixing chamber 2 or the fluid outlet 6.

The mixing chamber 2, the pneumatic chamber 4 and the fluid paths 6 and 10 act as a pneumatic valve in which centrifugal forces generate a pneumatic pressure in the pneumatic chamber 4, wherein said pneumatic pressure may be used for selectively forwarding liquids via the second fluid path radially inwards or via a siphon. The first and the second fluid paths 8 and 10 are configured such that, upon expansion of the compressed gas in the pneumatic chamber 4 with a first expansion rate, liquid is transferred out of the pneumatic chamber 4 into the mixing chamber 2 via the first fluid path 8 and such that, upon expansion of the compressed gas in the pneumatic chamber 4 with a second expansion rate larger than the first expansion rate, liquid is transferred out of the pneumatic chamber 4 to the fluid outlet 6 via the second fluid path 10. The different expansion rates may be generated by different braking rates (deceleration rates) with which the fluidic module M is decelerated from a higher rotation speed.

The first fluid path 8 represents a resistance channel that represents a higher fluidic resistance (flow resistance) for a fluid flow from the pneumatic chamber 4 to the mixing chamber 2 than the second fluid path 10 for a liquid flow from the pneumatic chamber to the flow outlet 6. When fluidic resistances are compared here, this applies to the same fluids at the same temperature, usually room temperature (20° C.). The second fluid path 10 comprises a portion that extends radially further inwards than the radially innermost portion of the first fluid path 8. Thus, starting from a state in which a compressible medium is compressed in the pneumatic chamber, it is possible to transfer liquid back into the mixing chamber 2 via the first fluid path 8 by decelerating the fluidic module M with a first deceleration rate, and to transfer liquid to the fluid outlet via the second fluid path 10 by decelerating the fluidic module with a second deceleration rate that is higher than the first deceleration rate. The radially innermost portion may be the radial position at which the first fluid path 8 leads into the mixing chamber 2, or may be an apex of a siphon when the first fluid path 8 comprises a siphon. The portion of the second fluid path 10 that extends radially further inwards than the radial innermost portion of the first fluid path 8 may be the fluid outlet 6, e.g. if the second fluid path 10 is fluidically coupled to an outlet chamber at the fluid outlet 6, or may be the apex of a siphon if the second fluid path 8 comprises a siphon.

With respect to the functionality of transferring the liquid to the first fluid path or the second fluid path or the implementation of the first fluid path and the second fluid path to achieve this functionality, reference is made to the teachings of DE10 2012 202 775 A1 and DE10 2013 203 293 A1, which are incorporated herein by reference. In contrast to know pneumatic microfluidic valves, according to the invention, the pressure equalization channel 12 is provided through which pressure equalization occurs which enables at least partially reducing a vapor pressure before the mouth of the pressure equalization channel 12 is closed by the liquid flowing in via the first fluid path 8. Thus, the invention enables robust shake-mode mixing even with frequency zero crossings.

The above implementation with respect to the examples show in FIG. 1 also apply to the other remaining examples described herein.

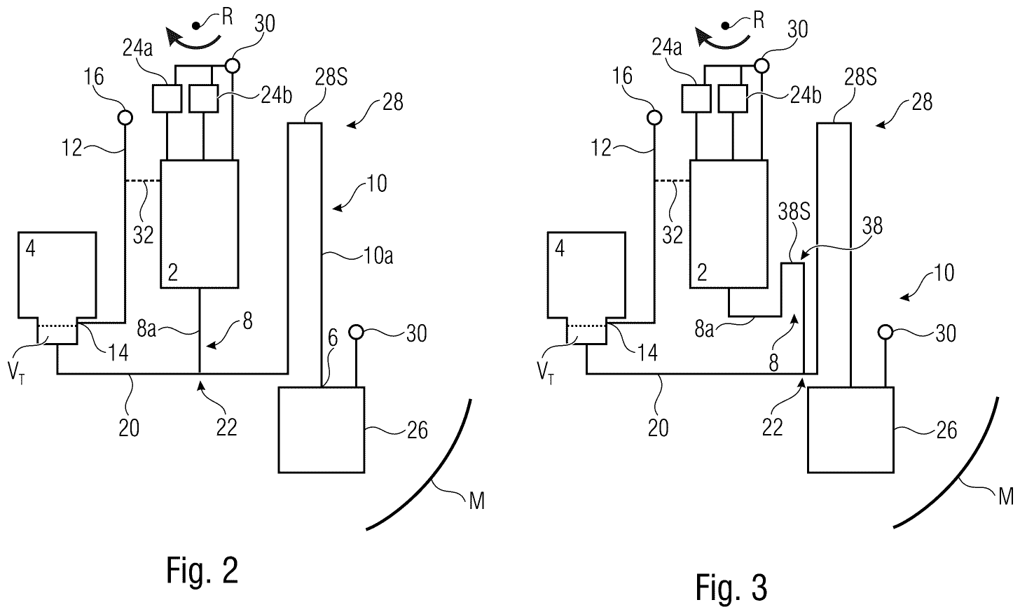

FIG. 2 show an example of an inventive fluidic module M in the shape of a centrifugal-pneumatic fluidic module for mixing and forwarding liquids. In addition to the mixing chamber 2, the pneumatic chamber 4, the fluid outlet 6, the first fluid path 8, the second fluid path 10 and the pressure equalization channel 12, the fluidic module shown in FIG. 2 additionally comprises several inlet chambers 24a, 24b, and an outlet chamber 26, wherein the mouth of the second fluid path 10 into the outlet chamber 26 represents the fluid outlet 6. The second fluid path 10 comprises a siphon 28 whose apex 28S is located radially further inwards than the mouth of the first fluid path 8 into the mixing chamber 6. The fluid outlet 6 is located radially further outwards than the mouth of the second fluid path 10 into the pneumatic chamber 4 so that the liquid can be drained out of the pneumatic chamber 4 into the outlet chamber 26 after fully priming the siphon 28. The first fluid path 8, and in particular the channel portion 8a of the T crossing 22 to the mixing chamber 2, comprises a high fluidic resistance that is higher than the fluidic resistance of the channel portion 10a from the T crossing 22 to the fluid outlet 6. In order to enable switching in the siphon 28, design parameters are selected such that when decelerating to transfer liquid into the outlet chamber 26, a sufficient amount of liquid enters into the siphon channel 28 so that the meniscus in the siphon channel 28 is located radially further outwards than the meniscus in the channel 8, or in the mixing chamber 2. Important design parameters are the rotation frequencies, the deceleration rate, the volumes of the pneumatic chamber 4 and the fluidic paths 8 and 28, the fluidic resistances of the pneumatic paths 8 and 28, the radial positions of the chambers, their mouths, the radial position of the siphon apex 28S and the geometries of the pneumatic chamber 4 and the mixing chamber 2. These are the most important parameters; however, further parameters may play a role. In examples, the first fluid path 8, and in particular the channel portion 8a from the T crossing 22 to the mixing chamber 2, may have a high fluidic resistance that is higher than the fluidic resistance of the channel portion 10a from the T crossing 22 to the fluid outlet 6. This may simplify selecting the desired parameters to enable switching of the siphon 28.

The mixing chamber 2, the inlet chambers 24a and 24b, and the outlet chamber 26 are de-aerated (or ventilated), as schematically shown in FIG. 2 by the de-aerations 30. The pressure equalization channel 12 de-aerates the pneumatic chamber 4 into the surroundings 16. Alternatively, as indicated by a channel 32 in FIG. 2, the pressure equalization channel 12 may be fluidically connected to a de-aerated area of the mixing chamber 2. The mouth 14 of the pressure equalization channel 12 into the pneumatic chamber 4 is located radially further inwards than the opening of the siphon channel 28 into the outlet chamber 26, i.e. than the fluid outlet 6. The mouth of the mutual channel 20 into the pneumatic chamber 4 is located radially further inwards than the fluid outlet 6.

As indicated in FIG. 2, a radially outer region of the pneumatic chamber may have a smaller cross-sectional area, when viewed in the radial direction, than the rest of the pneumatic chamber 4 to determine a defined volume VT indicated by a dotted line in FIG. 2. When this defined volume of the liquid has been transferred into the pneumatic chamber 4, the pressure equalization channel 12 is closed by this liquid.

The outlet chamber may be configured for processing the liquid by having reagents prestored in the same or by the same having structures that enable a division of the liquid in several sub-volumes. The outlet chamber may be configured for evaluation by having at least parts of the structures forming the outlet chamber being transparent to enable optical detection. The outlet chamber may be fluidically coupled to downstream fluidic structures, for example, an aliquoting structure.

Liquids to be mixed are guided, under rotation by centrifugal forces, from the inlet chambers 24a and 24b into the mixing chamber 2. Alternatively, only one of the inlet chambers could be provided, through which a liquid that is to be mixed through or that that is to be mixed with solids in the mixing chamber is introduced into the mixing chamber. Alternatively, different liquids may be introduced into the mixing chamber sequentially via the same inlet chamber. When filling the mixing chamber 2, liquid already enters into the pneumatic chamber 4 via the first fluid path 8 comprising the resistance channel 8a due to the rotation. Once the liquid reaches the pneumatic chamber 4, the gas saturates itself in the pneumatic chamber 4, and a vapor pressure is generated in the gas volume. As long as the fill level in the pneumatic chamber 4 is located radially further outwards than the opening (mouth) 14 of the pressure equalization channel 12, the vapor pressure escapes via the pressure equalization channel 12. If the fill level rises further, pneumatic pressure is generated in the pneumatic chamber 4 until an equalization between the centrifugal and the pneumatic pressure is achieved.

In order to perform a shake-mode mixing process, the liquids to be mixed are transferred into the mixing chamber 2. To this end, a slow deceleration takes place, i.e. the rotation frequency is reduced with such a low rate that liquid is pumped back into the mixing chamber 2 via the first fluid path by means of the pneumatic pressure in the pneumatic chamber 4. Due to the low deceleration rate, the expansion of the compressed gas in the pneumatic chamber 4 takes place sufficiently slowly so that switching (priming) the siphon 28 is prevented. If the deceleration would take place quickly, the siphon 28 would be switched. Due to the fact that the pressure has been reduced, the fill level in the pneumatic chamber 4 decreases upon slow acceleration only up to the opening 14 of the pressure equalization channel 12. A shake mode with frequency zero crossings (or without frequency zero crossings) may be performed and maintained for any duration.

Without the pressure equalization channel, the entire liquid could be pushed out of the pneumatic chamber 4 in case of low frequencies. On the one hand, this could lead to the fact that the T crossing is emptied and the air bubbles form in the mutual channel portion 20 and the siphon channel 28, preventing transfer through the siphon 28. On the other hand, this could lead to the fact that the siphon 28 switches too early. Both errors can be prevented by the pressure equalization channel 12.

After this shake-mode mixing, the mixed liquid can be transferred out of the mixing chamber back into the pneumatic chamber 4 by increasing the rotation frequency, so that a pneumatic pressure is generated in the pneumatic chamber 4. Due to a following quick deceleration, the siphon 28 is switched by the pneumatic pressure and the liquid may be transferred further radially outwards into the outlet chamber 26 via to the second fluid path 10.

The volume V_{T} located in the pneumatic chamber radially further outside than the opening 14 of the pressure equalization channel may be referred to as a dead volume since this volume is not mixed in the mixing chamber 2. Due to the low chamber volumes in microfluidic cartridges, the air saturates itself very quickly so that the overall vapor pressure may be reduced in case of a sufficiently large dead volume or a sufficiently slow filling. A suitable volume V_{T} may be set by the radial difference between the mouths of the first fluid path and the pressure equalization channel and a corresponding cross-sectional area of the region of the pneumatic chamber in that area.

As explained above, the pressure equalization channel 12 may serve as a de-aeration channel to reduce the vapor pressure in the pneumatic chamber 4 compared to the ambient pressure. If the mixing chamber 2 is de-aerated compared to the surroundings, the pressure equalization channel 12 may also be led from the pneumatic chamber 4 into the mixing chamber 2, as is schematically shown in FIG. 2 by a dotted line 32 representing a fluid channel. The direct connection of the pressure equalization channel 12 to the surroundings 16 may then be omitted. In this case, the pressure equalization channel 32 is to be led into the mixing chamber 2 radially further inwards than the maximum fill level in the mixing chamber 2. Depending on the implementation of the pneumatic valve, it may occur that liquid is pumped out of the pneumatic chamber 4 through the pressure equalization channel 32 into the mixing chamber 2. This does not represent a problem since these are the same liquids.

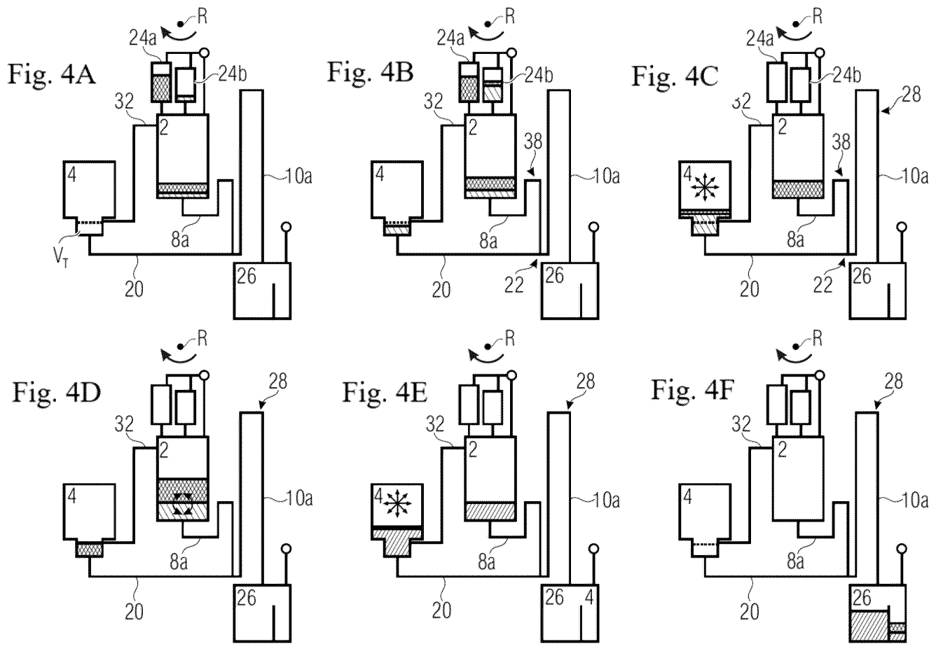

When transferring the liquids into the mixing chamber 2, air bubbles may form in the first fluid path 8 representing a resistance channel at the output of the mixing chamber 2. This may take place if the inflow speed into the mixing chamber 2 is lower than the outflow speed through the first fluid path 8. FIG. 3 shows an example of a fluidic module M in which such a bubble formation is prevented. In the following, only differences of the fluidic module shown in FIG. 3 compared to the fluidic module shown in FIG. 2 are described, wherein the above description otherwise also applies for the fluidic module M shown in FIG. 3. In the example shown in FIG. 3, the first fluid path 8 and in particular the channel portion 8a of the same comprises a siphon channel 38 forming a volume siphon in the resistance channel. The siphon channel 38 is configured such that it switches only once there is enough liquid in the mixing chamber 2 to fill the subsequent structures without bubbles. The siphon channel 38 therefore prevents instantaneous forwarding of the liquid into the pneumatic chamber 4 so that the inflow 24a and 24b may be lower than the outflow through the siphon channel 38 without air bubbles forming. An apex 38S of the siphon channel 38 is arranged radially further outwards than the apex 28S of the siphon channel 28 of the second fluid path 10.

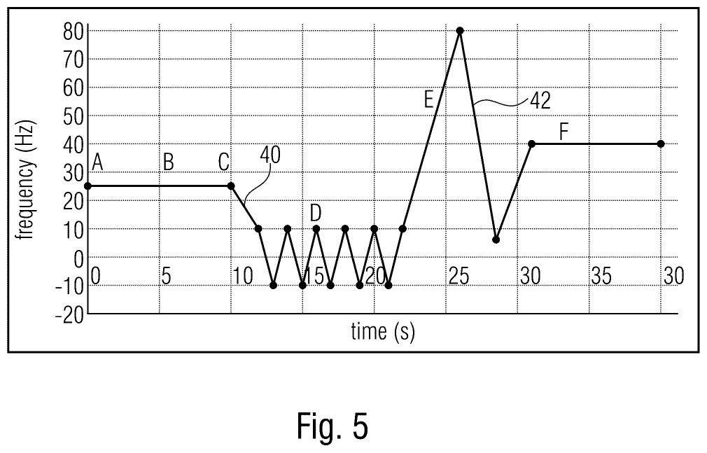

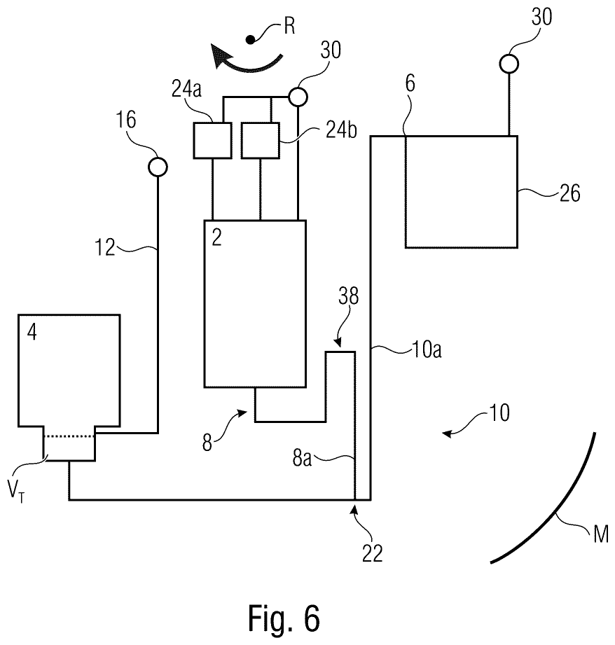

In the following, a method for shake-mode mixing using a fluidic module as shown in FIG. 3 is described with reference to FIGS. 4 and 5.

FIG. 4A through FIG. 4F show the fluidic module during different operation phases or process steps A to F of the method. As shown in FIG. 4A, in this example, the pressure equalization channel 32 leads into a de-aerated part of the mixing chamber 2, however, it could alternatively also be connected directly to the surroundings 16. FIG. 5 shows an example of a possible associated rotation frequency protocol, wherein the shown rotation frequencies are purely exemplary.

In an operation phase A, from the inlet chambers 24a and 24b, two liquids are transferred into the mixing chamber 2 under rotation. In this example, the liquid from the inlet chamber 24b has a higher density and it sediments in the mixing chamber 2. Once sufficient liquid is located in the mixing chamber 2, the siphon channel 28 is switched and the liquid reaches the pneumatic chamber 4 via the T crossing 22, as schematically shown in the operation phase B in FIG. 4B. Gas located in the pneumatic chamber 4 saturates itself, and vapor pressure is generated, which is reduced via the pressure equalization channel 32. If the liquid transfer into the pneumatic chamber 4 is sufficiently slow, the vapor pressure may be reduced fully. After a defined liquid volume (V_{T}) is transferred into the pneumatic chamber 4, the overpressure channel 32 is closed and the remaining gas volume is compressed in the further liquid transfer, cf. operation phase C in FIG. 4C.

After emptying the inlet chambers 24A and 24B, there is a slow deceleration to reduce the overpressure in the pneumatic chamber 4 without switching the siphon channel 28. The slow deceleration 40 (FIG. 5) takes place with a deceleration rate that is below a threshold deceleration rate at which a liquid transfer would be caused via the second fluid path 10, i.e. the siphon channel 28 would be switched, for example. This causes the gas to expand with such an expansion rate that the liquid is transferred out of the pneumatic chamber 4 back into the mixing chamber 2. A certain liquid volume corresponding to the dead volume V_{T} remains in the pneumatic chamber 4. On the one hand, this liquid volume cannot be mixed with a shake mode in the mixing chamber 2, on the other hand, this guarantees that the T crossing 22 never empties fully and that no air bubbles form there.

After the transfer of the liquid into the mixing chamber 2, shake-mode mixing takes place in the operation phase D (FIG. 4D). The shake-mode mixing may be carried out with frequency zero crossings since the pneumatic pressure in the pneumatic chamber 4 is not sufficient to switch the siphon channel 28. As shown in FIG. 5, the rotation frequency may be switched several time between different directions, wherein the rotation frequency remains lower than a rotation frequency that could be sufficient to switch the siphon channel 28. Due to the strong shake-mode process, liquids with density differences may be efficiently mixed as well. In alternative examples, mixing by changing the rotation frequency several times without switching a direction, e.g. by switching between different rotation frequencies of 5 Hz and 15 Hz, could be carried out. However, mixing with changing the rotation direction is more effective.

After the mixing process, the rotation frequency is increased to transfer the mixed liquids into the pneumatic chamber 4 and therefore generate a pneumatic pressure in the pneumatic chamber 4 at higher frequencies, operation phase E (FIG. 4E). Thereafter, a quick deceleration 42 takes place through which the siphon channel 28 is switched. The quick deceleration 42 takes place with a deceleration rate that is above the threshold deceleration rate so that the gas in the pneumatic chamber 4 expands with such an expansion rate that a liquid transfer is transferred into the outlet chamber 26 via the second fluid path 10. After the transfer into the outlet chamber, optionally, badly mixed fractions of the liquid may be separated, e.g. by using an increase of the rotation frequency, e.g. if the outlet chamber is configured accordingly, cf. operation phase F (FIG. 4F). For example, as indicated in FIG. 4F, the outlet chamber may have a separation wall through which such a separation could occur in case of change of the rotation frequency.

The rotation frequency during the operation phases A, B and C may be in a range that is higher than the rotation frequencies during mixing in operation phase D and lower than the rotation frequency in operation phase E, on the basis of which a liquid transfer takes place via the second fluid path. The rotation frequency during operation phases A, B and C may be in a range of 20 to 30 Hz, e.g. 25 Hz. Mixing may be done by switching between rotation frequencies below 15 Hz, e.g. switching between rotation frequencies of 10 Hz and-10 Hz. The rotation frequency in the operation phase E may be increased to a frequency above 50 Hz, e.g. 80 Hz.

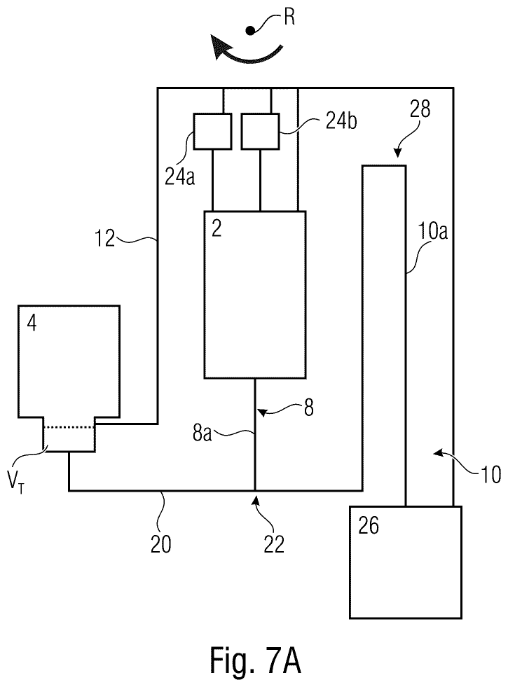

In examples, the fluidic module is implemented for pumping the liquid inwards. FIG. 6 shows an example of a fluidic module M, wherein differences with respect to the examples shown in FIG. 2 are described and reference is otherwise made to the above description. In the examples shown in FIG. 6, the second fluid path 10 and in particular the channel portion 10a does not comprise a siphon channel, but extends radially inwards to the fluid outlet 6. At the fluid outlet 6, the second fluid path leads into the outlet chamber 26. The fluid outlet 6, i.e. the mouth of the second fluid path 10 into the outlet chamber 26, is located radially further inwards than the mouth of the fluid path 10 into the pneumatic chamber 4 so that when transferring the liquid out of the pneumatic chamber 4 into the outlet chamber 26 via the second fluid path 10, the liquid is pumped inwards. The pressure reduction via the pressure equalization channel 12 prevents liquid being pumping inwards prematurely or bubble formation in the T crossing. The channel portion 10a of the second fluid path 10 connecting the T crossing 22 to the fluid outlet 6 comprises a lower fluidic resistance than the channel portion 8a of the first fluid path 8 connecting the T crossing 22 to the mixing chamber 2.

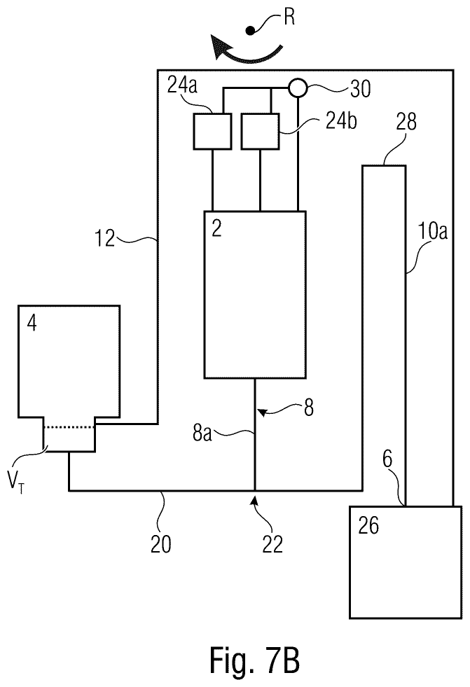

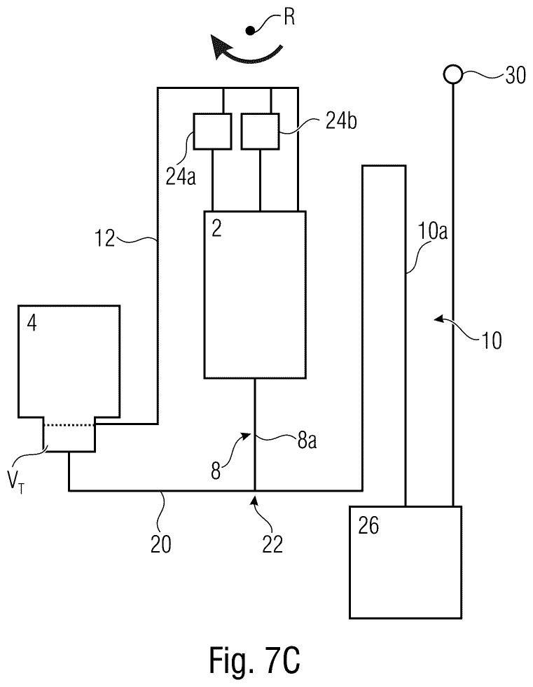

In the above examples, the mixing chamber is de-aerated, and, if present, the inlet chambers and the outlet chambers are de-aerated. In alternative examples, the fluidic module may implement a closed fluidic system. As shown in FIG. 7A, it is also possible that the fluid equalization channel is formed in a closed structure. The pressure equalization channel 12 fluidically connects the pneumatic chamber 4 to the other fluidic structures, there is no connection to the surroundings. More precisely, the pressure equalization channel 12 connects the pneumatic chamber 4 to the inlet chambers 24a, 24b, the mixing chamber 2, and the outlet chamber 26. In this case, pressure equalization takes place in the entire fluidic structure. There is no premature switching of the siphon channel 28 since the pneumatic chamber 4 does not comprise any overpressure with respect to the outlet chamber 26.

FIG. 7B shows an example in which the pressure equalization channel 12 fluidically connects the pneumatic chamber 4 to the outlet chamber 26 and therefore to the fluid outlet 6. The mixing chamber 2 is de-aerated (ventilated) into the surroundings. After closing the pressure equalization channel 12, it is possible to return to low rotation frequencies without prematurely switching the siphon channel 28.

FIG. 7C shows an example in which the pressure equalization channel 12 fluidically connects the pneumatic chamber 4 to the mixing chamber 2 and the inlet chambers 24a and 24b. However, this example is complicated in its implementation since, after closing the pressure equalization channel 12, a further transfer out of the mixing chamber 2 generates a negative pressure in the mixing chamber 2.

In the examples shown in FIGS. 7A to 7C, the pressure equalization channel differs from the examples shown in FIG. 2. In addition, the above explanations also apply for the examples shown in FIGS. 7A to 7C.

Examples of the present invention provide a fluid handling device comprising fluidic module M described herein and a drive device to rotate the fluidic module to achieve the functionality described herein.

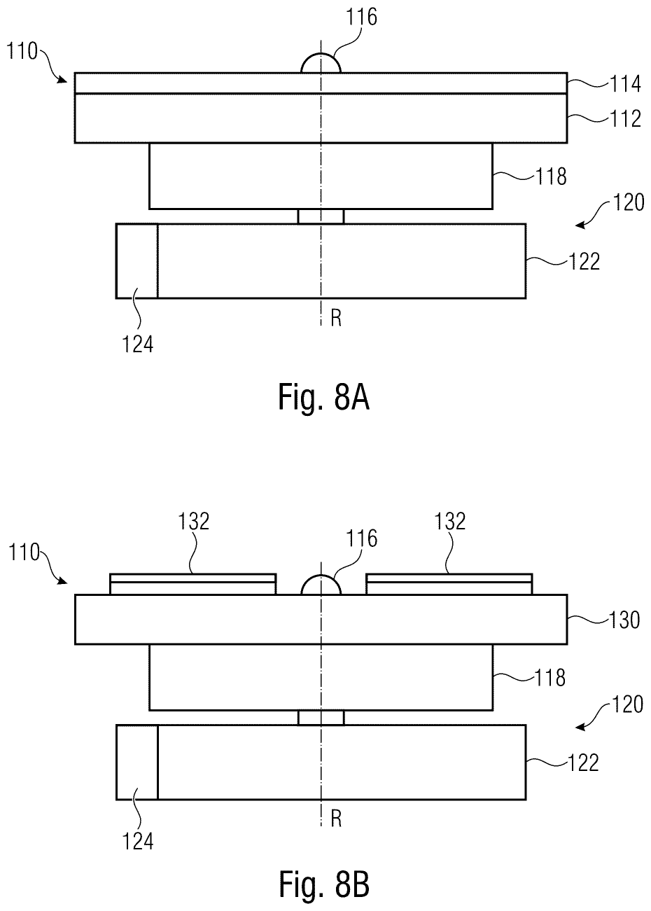

With reference to FIGS. 8A and 8B, examples of fluid handling devices in the form of centrifugal-microfluidic systems according to examples of the invention are now described, comprising a fluidic module as described herein, or using the same. In other words, the fluidic module may be any of the fluidic modules described herein in the systems in FIGS. 8A and 8B.

FIG. 8A shows a fluid handling device with a fluidic module in the form of a rotation body 110 comprising a substrate 112 and a cap 114. The substrate 112 and the cap 114 may be circular in a top view, having a central opening above which the rotation body 110 may be attached via a conventional fixing means 116 at a rotating part 118 of a drive device 120. The rotating part 118 is rotatably supported at a stationary part 122 of the drive device 120. For example, the drive device 120 may be a conventional centrifuge, which may comprise an adjustable rotation speed, or also a CD or DVD drive. Means for control 124 may be provided, configured to control the drive device 120 to apply a rotation or rotations with different rotation frequencies to the rotation body 110. As is obvious to those skilled in the art, the means for control 124 may be implemented by correspondingly programmed means for computing or an application-specific integrated circuit. In addition, the means for control 124 may be configured to control the drive device 120 as a response to manual inputs by the user to cause the required rotations of the rotation body. In each case, the means for control 124 may be configured to control the drive device 120 to apply the required rotation to the rotation body in order to implement examples of the invention as described herein. A conventional centrifuge with only one rotation direction may be used as the drive device 120.

The rotation body 110 comprises the fluidic structures that form the fluidic modules as described herein. The fluidic structures may be formed by cavities and channels in the cap 114, the substrate 112, or in the substrate 112 and the cap 114. In examples, fluidic structures may be formed in the substrate 112, while filling openings and de-aeration openings are formed in the cap 114. In examples, the structured substrate (including filling openings and de-aeration openings) are arranged above and the cap is arranged below.

In an alternative example shown in FIG. 8B, fluidic modules 132 are inserted into a rotor 130, forming the rotation body 110 together with the rotor 130. The fluidic modules 132 may each comprise a substrate and a cap in which corresponding fluidic structures may be formed. The rotation body 110 formed by the rotor 130 and the fluidic module 132 may in turn be applied with a rotation by the drive device 120 controlled by the means for control 124.

In FIGS. 8A and 8B the rotation center around which the fluidic module or the rotation body can be rotated is referred to with R.

In examples of the invention, the fluidic module or the rotation body comprising the fluidic structures may be formed from any suitable material, e.g. a plastic, such as PMMA (polymethyl methacrylate), PC (polycarbonate), PVC (polyvinyl chloride) or PDMS (polydimethylsiloxane), glass or the like. The rotation body 110 can be regarded as a centrifugal microfluidic platform. In preferred examples, the fluidic module or the rotating body may be formed from a thermoplastic, such as PP (polypropylene), PC, COP (cyclic olefin polymer), COC (cyclo olefin copolymer), or PS (polystyrene).

In examples, the drive device 120 and any of the fluidic modules described herein form an example of an inventive fluid handling device. In examples, the drive device is configured, e.g. controlled by the controller 124, to
in a first phase, rotate the fluidic module M with a rotation frequency to transfer liquid out of the mixing chamber 2 into the pneumatic chamber 4 and to compress gas enclosed in the pneumatic chamber4,
in a second phase, reduce the rotation frequency with a deceleration rate at which the compressed gas expands with an expansion rate that causes liquid to be transferred out of the pneumatic chamber 4 into the mixing chamber 2 via the first fluid path 8,
in a third phase, control the rotation frequency to switch several times between rotations in different directions or to switch several times between different rotation frequencies in one rotation direction in order to cause mixing of the liquid in the mixing chamber 2,
in a fourth phase, increase the rotation frequency to transfer the liquid out of the mixing chamber 2 into the pneumatic chamber 4 and to compress gas enclosed in the pneumatic chamber 2,
in a fifth phase, reduce the rotation frequency with a deceleration rate at which the compressed gas expands with an expansion rate that causes liquid to be transferred out of the pneumatic chamber 4 to the fluid outlet 6 via the second fluid path 10.

In examples, the drive device is configured to perform a method as described above with reference to FIGS. 4 and 5. It goes without saying that a method such as that described above with reference to the example shown in FIG. 3 can also be carried out with appropriate modifications in the other examples described.

Examples of the present invention provide corresponding methods for effective mixing. Such methods may be performed using fluidic modules and fluid handling devices as described herein. When mixing, a liquid may be mixed, several liquids may be mixed with each other, particles may be agitated, solids prestored in the mixing chamber may be dissolved, or one or several liquids may be mixed with solids, such as lyophilized pellets, prestored in the mixing chamber. In examples, the fluidic module comprises solids prestored in the mixing chamber, e.g. lyophilized pellets, that are to be mixed with liquid(s). In particular, components to be mixed having density differences may be mixed, e.g. when mixing blood plasma with buffers or when dissolving lyophilized pellets.

Examples of the invention relate to the enhancement of a pneumatic valve with respect to a pressure equalization channel at the pneumatic chamber. When filling the pneumatic chamber with liquid, the pressure equalization channel (de-aeration channel) is closed from a defined liquid volume. When filling the pneumatic chamber, vapor pressure is created, which may escape until closing the pressure equalization channel. Through this, the pneumatic valve may also be operated at low frequencies without the siphon being switched.

Through this, the invention enables shake-mode mixing using shake-mode protocols with frequency zero crossings in pneumatic valves. This enables quick mixing of liquids with density differences. In comparison, reciprocal mixing with a pneumatic valve is slow, since the deceleration is slow in order to prevent premature switching via the siphon channel. In addition, reciprocal mixing results in poor mixing of liquids with differences in density due to constant sedimentation.

Conventional pneumatic valves without a pressure equalization channel can only be operated at low frequencies and require a lot of space and their design is complex. If the vapor pressure is not reduced they are not very robust. This is critical because fluctuations occur in production, in the volume and properties of liquids, in temperature, in humidity, in rotation frequency and in acceleration. In contrast, in examples of the invention enable a more flexible and simpler design of pneumatic valves and an increase in the robustness of pneumatic valves against such tolerances.

Even though features of the invention have been described in terms of device features or method features, it is obvious to those skilled in the art that corresponding features may also be part of a method or a device. Thus, the device may be configured to perform corresponding method steps, and the respective functionality of the device may represent corresponding method steps.

In the above detailed description, various features have in some cases been grouped together in examples in order to streamline the disclosure. This type of disclosure should not be interpreted as meaning that the claimed examples have more features than are expressly stated in each claim. Rather, as the following claims reflect, the subject matter may lie in fewer than all of the features of a single disclosed example. Consequently, the following claims are hereby incorporated into the detailed description, each claim being capable of standing as a separate example. While each claim can stand as a separate example, it should be noted that although dependent claims refer to a specific combination with one or more other claims, other examples may also include a combination of dependent claims with the subject matter of any other dependent claim or a combination of any feature with other dependent or independent claims. Such combinations are included unless it is stated that a specific combination is not intended. Furthermore, it is intended that a combination of features of a claim with any other independent claim is also included, even if that claim is not directly dependent on the independent claim.

The examples described above are only illustrative of the principles of the present disclosure. It should be understood that modifications and variations of the arrangements and details described are obvious to those skilled in the art. It is therefore intended that the disclosure be limited only by the appended claims and not by the specific details set forth for the purpose of describing and explaining the examples.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A fluidic module, comprising:
a mixing chamber,
a pneumatic chamber,
a fluid outlet,
a first fluid path that fluidically connects the mixing chamber to the pneumatic chamber to be able to centrifugally transfer liquid out of the mixing chamber into the pneumatic chamber,
a second fluid path that fluidically connects the pneumatic chamber to the fluid outlet,
a pressure equalization channel that fluidically connects the pneumatic chamber to the surroundings, the mixing chamber and/or the fluid outlet to enable a pressure equalization, and that leads into the pneumatic chamber at a pressure equalization mouth, wherein this pressure equalization mouth is arranged at such a position that it is closed by liquid that is transferred into the pneumatic chamber via the first fluid path after a defined volume of the liquid has been transferred into the pneumatic chamber to compress, after closing, in a further centrifugal transfer of liquid out of the mixing chamber into the pneumatic chamber, a gas enclosed in the pneumatic chamber.
wherein an expansion of the compressed gas in the pneumatic chamber with a first expansion rate causes liquid to be transferred out of the pneumatic chamber into the mixing chamber via the first fluid path, and
wherein an expansion of the compressed gas in the pneumatic chamber with a second expansion rate larger than the first expansion rate causes liquid to be transferred out of the pneumatic chamber to the fluid outlet via the second fluid path.

2. The fluidic module according to claim 1, wherein the second fluid path comprises a siphon channel whose apex is arranged radially further inwards than a radially innermost portion of the first fluid path.

3. The fluidic module according to claim 1, wherein the second fluid path for a flow of liquid from the pneumatic chamber to the fluid outlet comprises a lower fluidic resistance than the first fluid path for a flow of liquid from the pneumatic chamber into the mixing chamber, and wherein the second fluid path comprises a channel portion that extends radially further inwards than a radially innermost portion of the first fluid path.

4. The fluidic module according to claim 1, wherein the fluid outlet is arranged radially further inwards than a radial position at which the second fluid path leads into the pneumatic chamber.

5. The fluidic module according to claim 1, wherein an end, spaced apart from the pressure equalization mouth, of the pressure equalization channel leads into the surroundings or into a de-aerated region of the mixing chamber.

6. The fluidic module according to claim 1, wherein the position of the pressure equalization mouth is located radially further inwards than a position at which the first fluid path leads into the pneumatic chamber.

7. The fluidic module according to claim 1, wherein the first fluid path and the second fluid path comprise a mutual channel portion that leads into the pneumatic chamber, wherein the mutual channel portion is divided at a branch into a first portion, opening into the mixing chamber, of the first fluid path and a second portion, leading to the fluid outlet, of the second fluid path.

8. The fluidic module according to claim 1, wherein the first fluid path leads into the mixing chamber in a radially outer region of the mixing chamber and/or wherein the first and the second fluid paths lead into the pneumatic chamber in a radially outer region of the pneumatic chamber.

9. The fluidic module according to claim 1, further comprising an inlet chamber or several inlet chambers fluidically coupled to the mixing chamber to centrifugally transfer liquid out of the one or the several inlet chambers into the mixing chamber.

10. The fluidic module according to claim 1, further comprising an outlet chamber into which an end, spaced apart from the pneumatic chamber, of the second fluid path leads and that is configured to receive liquid transferred via the second fluid path to the fluid outlet.

11. The fluidic module according to claim 1, wherein the first fluid path comprises a siphon channel configured to switch if a liquid level in the mixing chamber exceeds a predetermined level, wherein an apex of the siphon channel of the first fluid path represents a or the radially innermost portion of the first fluid path.

12. A fluid handling device, comprising:
a fluidic module according to claim 1, and
a drive device configured to rotate the fluidic module, wherein the drive device is configured to:
in a first phase, rotate the fluidic module with a rotation frequency to transfer liquid out of the mixing chamber into the pneumatic chamber and to compress gas enclosed in the pneumatic chamber,
in a second phase, reduce the rotation frequency with a deceleration rate at which the compressed gas expands with an expansion rate that causes liquid to be transferred out of the pneumatic chamber into the mixing chamber via the first fluid path,
in a third phase, control the rotation frequency to switch several times between rotations in different directions or to switch several times between different rotation frequencies in one rotation direction in order to cause mixing of the liquid in the mixing chamber,
in a fourth phase, increase the rotation frequency to transfer the liquid out of the mixing chamber into the pneumatic chamber and to compress gas enclosed in the pneumatic chamber,
in a fifth phase, reduce the rotation frequency with a deceleration rate at which the compressed gas expands with an expansion rate that causes liquid to be transferred out of the pneumatic chamber to the fluid outlet via the second fluid path.

13. A method for mixing one or several liquids using a fluidic module according to claim 1, comprising:
introducing one or several liquids into the mixing chamber,
rotating the fluidic module with a rotation frequency to transfer liquid out of the mixing chamber into the pneumatic chamber and to compress gas enclosed in the pneumatic chamber,
reducing the rotation frequency with a deceleration rate at which the compressed gas expands with an expansion rate that causes liquid to be transferred out of the pneumatic chamber into the mixing chamber via the first fluid path,
controlling the rotation frequency to switch several times between rotations in different directions or to switch several times between different rotation frequencies in one rotation direction in order to cause mixing of the liquid in the mixing chamber and/or to cause mixing of the liquid in the mixing chamber with solids prestored in the mixing chamber,
increasing the rotation frequency in order to transfer the liquid out of the mixing chamber into the pneumatic chamber and to compress gas enclosed in the pneumatic chamber, and
reducing the rotation frequency with a deceleration rate at which the compressed gas expands with an expansion rate that causes liquid being transferred out of the pneumatic chamber to the fluid outlet via the second fluid path.

14. The method according to claim 13, wherein introducing one or several liquids into the mixing chamber takes place under a rotation of the fluidic module to centrifugally transfer the one or several liquids from one or several inlet chambers into the mixing chamber.

15. The method according to claim 13, wherein an overpressure created by saturation of the gas in the pneumatic chamber when the liquid is transferred from the mixing chamber into the pneumatic chamber is at least partially reduced via the pressure equalization channel.
